(19) United States
(12) Patent Application Publication
(10) Pub. No.: US 2024/0349031 A1
(43) Pub. Date: Oct. 17, 2024

(54) CLOSED LOOP COMMANDS FOR EXTENDING VALIDITY DURATIONS

(71) Applicant: QUALCOMM Incorporated, San Diego, CA (US)

(72) Inventors: Alberto RICO ALVARINO, San Diego, CA (US); Ayan SENGUPTA, San Diego, CA (US); Bharat SHRESTHA, San Diego, CA (US); Umesh PHUYAL, San Diego, CA (US)

(21) Appl. No.: 18/604,961

(22) Filed: Mar. 14, 2024

Related U.S. Application Data
(60) Provisional application No. 63/496,312, filed on Apr. 14, 2023.

(51) Int. Cl. H04W 8/18

(52) U.S. Cl. CPC H04W 8/18

(57) ABSTRACT

Various aspects of the present disclosure generally relate to wireless communication. In some aspects, a user equipment (UE) may determine a global navigation satellite system (GNSS) position associated with the UE, the GNSS position being associated with a GNSS validity timer. The UE may receive, in a connected mode, a closed loop command that is associated with a closed loop timer. The UE may perform an action based at least in part on an expiry of the GNSS validity timer and an expiry of the closed loop timer. Numerous other aspects are described.

### CROSS-REFERENCE TO RELATED APPLICATION

This patent application claims priority to U.S. Provisional Patent Application No. 63/496,312, filed on Apr. 14, 2023, entitled “CLOSED LOOP COMMANDS FOR EXTENDING VALIDITY DURATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for closed loop commands for extending validity durations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: determine a global navigation satellite system (GNSS) position associated with the UE, the GNSS position being associated with a GNSS validity timer; receive, in a connected mode, a closed loop command that is associated with a closed loop timer; and perform an action based at least in part on an expiry of the GNSS validity timer and an expiry of the closed loop timer.

In some implementations, a method of wireless communication performed by a UE includes determining a GNSS position associated with the UE, the GNSS position being associated with a GNSS validity timer; receiving, in a connected mode, a closed loop command that is associated with a closed loop timer; and performing an action based at least in part on an expiry of the GNSS validity timer and an expiry of the closed loop timer.

In some implementations, a non-transitory computer-readable medium storing a set of instructions for wireless communication includes one or more instructions that, when executed by one or more processors of a UE, cause the UE to: determine a GNSS position associated with the UE, the GNSS position being associated with a GNSS validity timer; receive, in a connected mode, a closed loop command that is associated with a closed loop timer; and perform an action based at least in part on an expiry of the GNSS validity timer and an expiry of the closed loop timer.

In some implementations, an apparatus for wireless communication includes means for determining a GNSS position associated with the apparatus, the GNSS position being associated with a GNSS validity timer; means for receiving, in a connected mode, a closed loop command that indicates a time correction or a frequency correction for an uplink transmission of the apparatus, the closed loop command being associated with a closed loop timer; and means for performing an action based at least in part on an expiry of the GNSS validity timer and an expiry of the closed loop timer.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a non-terrestrial network (NTN) architecture, in accordance with the present disclosure.

FIGS. 5-6 are diagrams illustrating examples associated with closed loop commands for extending validity durations, in accordance with the present disclosure.

FIG. 7 is a diagram illustrating an example process associated with closed loop commands for extending validity durations, in accordance with the present disclosure.

FIG. 8 is a diagram of an example apparatus for wireless communication, in accordance with the present disclosure.

### DETAILED DESCRIPTION

A UE, such as an enhanced machine-type communication (eMTC) UE or a narrowband Internet of Things (IoT) (NB-IoT) UE, may be associated with complexity limitations. The UE may be unable to use a global navigation satellite system (GNSS) and eMTC/NB-IoT at the same time. The UE may first obtain a GNSS position associated with the UE, and then the UE may use eMTC/NB-IoT. The UE may start a timer when starting to use eMTC/NB-IoT. An expiry of the timer may indicate that the GNSS position is no longer valid. The UE may enter an idle mode based at least in part on the expiry of the timer. When in the idle mode, the UE may reacquire the GNSS position (e.g., a latest GNSS position), and then the UE may go back to eMTC/NB-IoT, and this process may repeat.

When transmitting a relatively small packet, switching between the idle mode (e.g., to reacquire the GNSS position) and a connected mode for eMTC/NB-IoT may be acceptable. However, in some cases, an ability to support longer connections (e.g., during which the UE may be able to remain in the connected mode) may be desirable. For example, longer connections may be needed for a voice call or for downloading a relatively large file. When the longer connections are not supported, the UE may need to periodically (e.g., every two minutes) switch to idle mode, reacquire the GNSS position, and then reconnect to a non-terrestrial network (NTN). Such an approach may result in dropped voice calls, a disruption when downloading relatively large files, and/or increased signaling overhead.

In some aspects described herein, a UE may determine a GNSS position associated with the UE. The GNSS position may be associated with a GNSS validity timer. The UE may start the GNSS validity timer after determining the GNSS position. The GNSS validity timer may be executed at the UE. The UE may receive, from a network node and while in a connected mode, a closed loop command that indicates a time correction an/or a frequency correction. The time correction and/or the frequency corrections may be for uplink transmissions of the UE. The closed loop command may be associated with a closed loop timer. The UE may start the closed loop timer after receiving the closed loop command. The closed loop timer may be executed at the UE. The UE may determine that the GNSS validity timer has expired and that the closed loop timer has expired. The UE may perform an action based at least in part on an expiry of the GNSS validity timer and an expiry of the closed loop timer. For example, the UE may move from the connected mode to an idle mode, the UE may declare a radio link failure (RLF), or the UE may reacquire the GNSS position (e.g., perform a GNSS reacquisition), which may involve determining an updated GNSS position associated with the UE.

In some aspects, the closed loop command, and the associated closed loop timer, may allow the UE to extend a validity of the GNSS position. Even when the UE has changed locations and the GNSS position is no longer accurate, the UE may receive the closed loop command from the network node, which may compensate for the UE's movement. The UE does not need to immediately go to the idle mode and reacquire the GNSS position after the UE moves to a different location. Rather, after receiving the closed loop command, the UE may remain in the connected mode until the closed loop timer expires. An ability to remain in the connected mode for an extended period of time may prevent dropped voice calls or breakages when downloading relatively large files, and may reduce a signaling overhead of the UE, thereby improving an overall performance of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

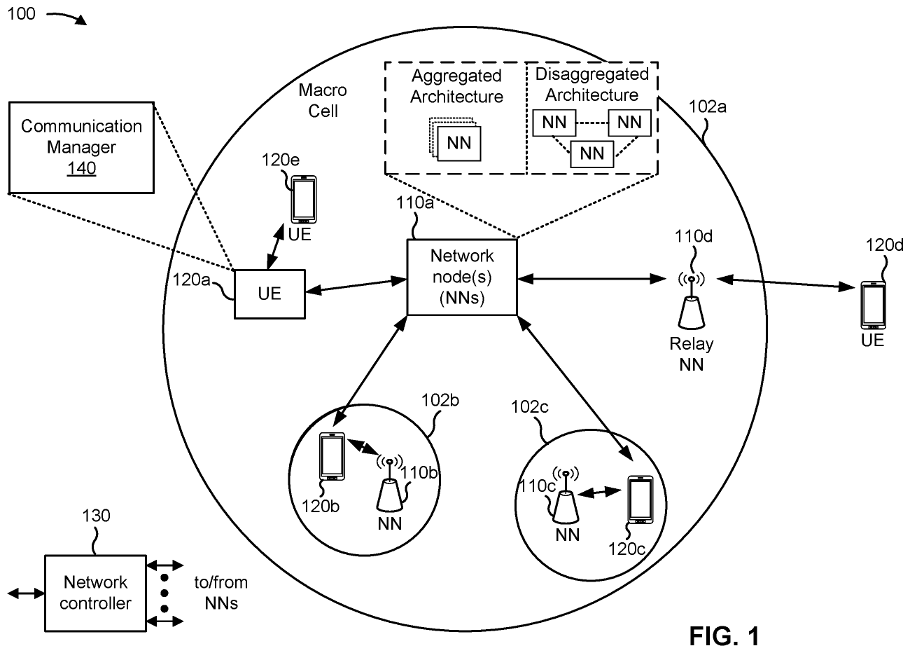

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or eMTC UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered IoT devices, and/or may be implemented as NB-IoT devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may determine a GNSS position associated with the UE, the GNSS position being associated with a GNSS validity timer; receive, in a connected mode, a closed loop command that is associated with a closed loop timer; and perform an action based at least in part on an expiry of the GNSS validity timer and an expiry of the closed loop timer. Additionally, or alternatively, the communication manager 140 may perform one or more other operations described herein.

As indicated above, FIG. 1 is provided as an example. Other examples may differ from what is described with regard to FIG. 1.

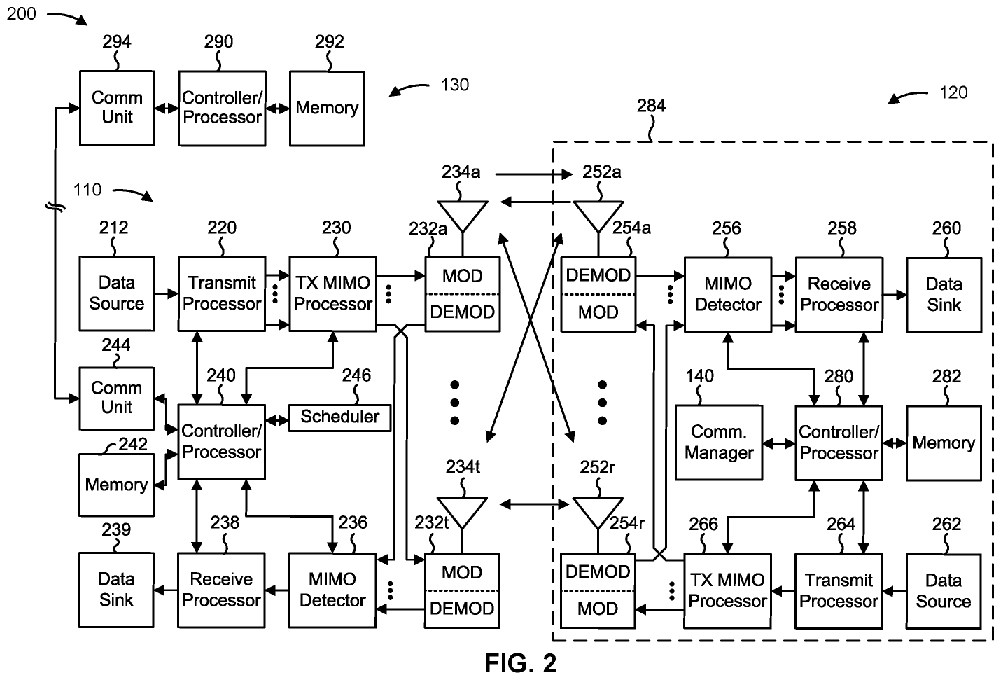

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

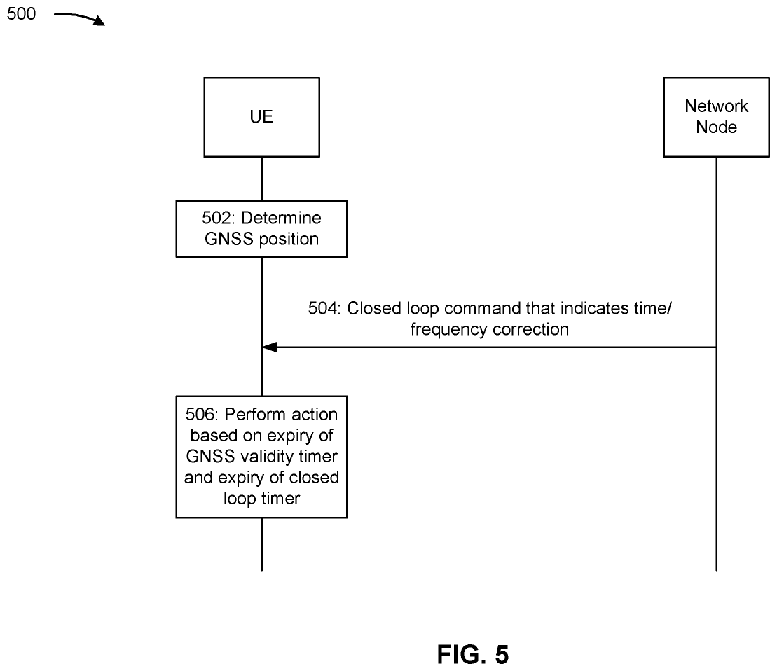

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

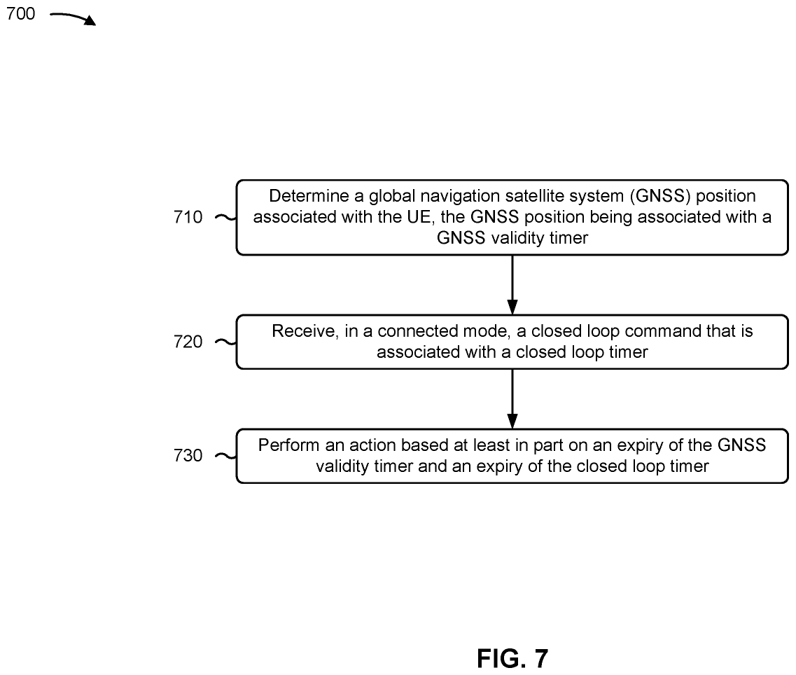

The controller/processor 240 of the network node 110, the controller/processor 280 of the UE 120, and/or any other component(s) of FIG. 2 may perform one or more techniques associated with closed loop commands for extending validity durations, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, and/or other processes as escribed herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for determining a GNSS position associated with the UE, the GNSS position being associated with a GNSS validity timer; means for receiving, in a connected mode, a closed loop command that is associated with a closed loop timer; and/or means for performing an action based at least in part on an expiry of the GNSS validity timer and an expiry of the closed loop timer. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

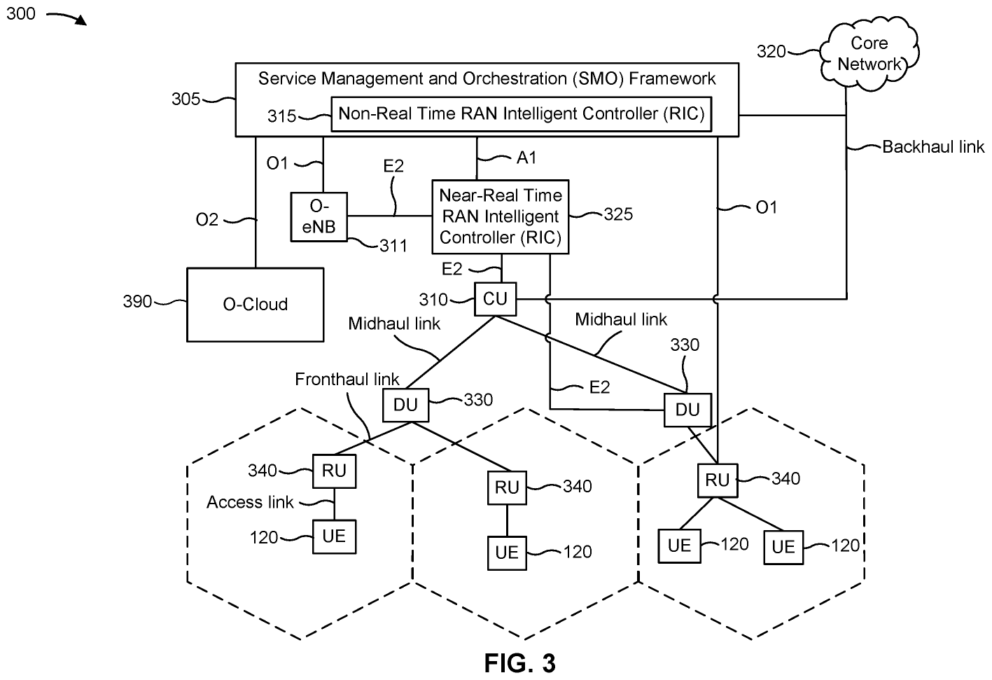

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

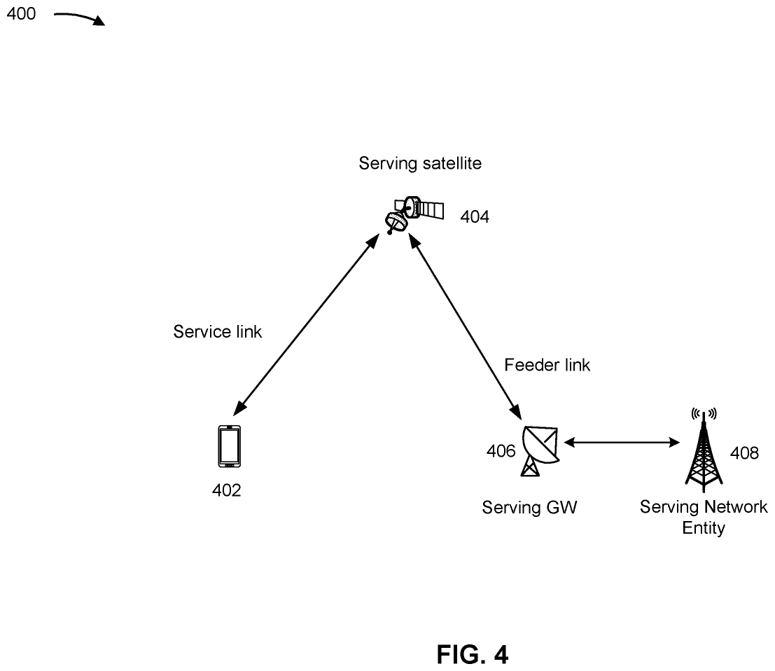

FIG. 4 is a diagram illustrating an example of an NTN architecture 400, in accordance with the present disclosure.

As shown in FIG. 4, a UE 402 in a connected mode may communicate with a serving network entity 408 via a serving satellite 404 in the NTN architecture 400. The UE 402 may transmit an uplink transmission to the serving satellite 404. The serving satellite 404 may relay the uplink transmission to the serving network entity 408 via a serving gateway 406. The serving network entity 408 may transmit a downlink transmission to the serving satellite 404 via the serving gateway 406. The serving satellite 404 may relay the downlink transmission to the UE 402. A link between the UE 402 and the serving satellite 404 may be a service link, and a link between the serving satellite 404 and the serving gateway 406 may be a feeder link.

As indicated above, FIG. 4 is provided as an example. Other examples may differ from what is described with regard to FIG. 4.

A UE, before connecting to an NTN, may determine a GNSS position associated with the UE. The GNSS position may be associated with a geographic location of the UE. The UE may receive, from a satellite associated with the NTN, a system information block (SIB). The SIB may indicate a satellite location and/or a satellite speed associated with the satellite. The UE, before transmitting an uplink transmission, may determine a pre-compensation to be applied to the uplink transmission. The UE may determine a delay and/or a Doppler shift seen by the satellite, which may be based at least in part on the GNSS position, the satellite location, and/or the satellite speed. The UE may determine the pre-compensation based at least in part on the delay and/or the Doppler shift seen by the satellite. The UE may adjust the uplink transmission based at least in part on the pre-compensation, such that no timing error (or minimum timing error) associated with the uplink transmission is experienced by the satellite.

A UE, such as an eMTC UE or an NB-IoT UE, may be associated with complexity limitations. The UE may be unable to use GNSS and eMTC/NB-IoT at the same time. The UE may first obtain the GNSS position, and then the UE may use eMTC/NB-IoT. The UE may start a timer when starting to use eMTC/NB-IoT. An expiry of the timer may indicate that the GNSS position is no longer valid. The UE may enter an idle mode based at least in part on the expiry of the timer. When in the idle mode, the UE may reacquire the GNSS position (e.g., a latest GNSS position), and then the UE may go back to eMTC/NB-IoT, and this process may repeat.

A GNSS position validity duration (gnss-validityDuration) may be a UE-indicated value with a remaining time of a GNSS position validity. In other words, the GNSS position validity duration may be associated with a period of time for which the GNSS position is valid. After an expiry of the GNSS position validity duration, the UE may go back to the idle mode. For example, based at least in part on the GNSS position becoming outdated while the UE is in a connected mode, the UE may go back to the idle mode to reacquire the GNSS position.

When transmitting a relatively small packet, switching between the idle mode (e.g., to reacquire the GNSS position) and a connected mode for eMTC/NB-IoT may be acceptable. However, in some cases, an ability to support longer connections (e.g., during which the UE may be able to remain in the connected mode) may be desirable. For example, longer connections may be needed for a voice call or for downloading a relatively large file. When the longer connections are not supported, the UE may need to periodically (e.g., every two minutes) switch to idle mode, reacquire the GNSS position, and then reconnect to the NTN. Such an approach may result in dropped voice calls, a disruption when downloading relatively large files, and/or increased signaling overhead.

As a result, for an NTN and an eMTC/NB IoT scenario, an improved GNSS operation for a new position fix (e.g., reacquiring the GNSS position) for a UE pre-compensation may be needed for relatively long connection times and for reducing a power consumption. A simultaneous GNSS and NTN NB-IoT/eMTC operation may not be assumed.

In various aspects of techniques and apparatuses described herein, a UE may determine a GNSS position associated with the UE. The GNSS position may be associated with a GNSS validity timer. The UE may start the GNSS validity timer after determining the GNSS position. The GNSS validity timer may be executed at the UE. The UE may receive, from a network node and while in a connected mode, a closed loop command that indicates a time correction an/or a frequency correction. The time correction and/or the frequency corrections may be for uplink transmissions of the UE. The closed loop command may be associated with a closed loop timer. The UE may start the closed loop timer after receiving the closed loop command. The closed loop timer may be executed at the UE. The UE may determine that the GNSS validity timer has expired and that the closed loop timer has expired. The UE may perform an action based at least in part on an expiry of the GNSS validity timer and an expiry of the closed loop timer. For example, the UE may move from the connected mode to an idle mode, the UE may declare an RLF, or the UE may reacquire the GNSS position (e.g., perform a GNSS reacquisition), which may involve determining an updated GNSS position associated with the UE.

In some aspects, the UE may determine the GNSS position (e.g., an initial GNSS position) associated with the UE, and then the UE may use eMTC/NB-IoT. For example, the UE may connect to an NTN and operate in an eMTC/NB-IoT mode. When the UE is using eMTC/NB-IoT, the UE may move to a different location, but the UE may be unable to determine the location because the UE may not be able to use GNSS and eMTC/NB-IoT at the same time. Due to the UE movement (e.g., away from a satellite), the satellite may detect that a timing of the UE is now associated with a drift. In response, a network node may issue the closed loop command to the UE, where the closed loop command may instruct the UE to adjust its timing by a certain amount due to the UE movement. As a result, even when the GNSS position is stale, the UE may remain in the connected mode (and not revert back to the idle mode to reacquire the GNSS position) based at least in part on the closed loop command received from a network node. The closed loop command received from the network node may allow the UE to extend its validity duration for the GNSS position, such that the GNSS position may be able to stay valid for an extended period of time, and the UE may not be forced to prematurely revert to the idle mode to reacquire the GNSS position. By issuing the closed loop command to extend the validity duration for the GNSS position, the UE may support a longer connection time without needing to reacquire the GNSS position. The longer connection time may prevent dropped voice calls or breakages when downloading relatively large files, and the longer connection time may reduce a signaling overhead for the UE, thereby improving a performance of the UE.

In some aspects, when a time/frequency error associated with the UE, which may be due to a movement associated with the UE, is within a time/frequency error requirement, the UE may perform the uplink transmission after a GNSS position validity duration (or an original GNSS validity duration) expires without a GNSS position reacquisition for a duration of time. The duration of time may be based at least in part on the extended validity duration for the GNSS position. The UE may be allowed to perform the uplink transmission after the GNSS position validity duration expires based at least in part on the closed loop command received from the network node. The closed loop command may indicate a closed loop time/frequency correction, which may be applied by the UE during the uplink transmission. The network node may configure or enable the UE to receive and apply the closed loop time/frequency correction to the uplink transmission.

FIG. 5 is a diagram illustrating an example 500 associated with closed loop commands for extending validity durations, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

In some aspects, the UE may be an eMTC/NB-IoT UE. The UE may be associated with an NTN. The UE may not be capable of a simultaneous GNSS and NTN eMTC/NB-IoT operation. For example, when the UE is acquiring a GNSS position associated with the UE, the UE may be unable to perform the NTN eMTC/NB-IoT operation. When the UE is performing the NTN eMTC/NB-IoT operation, the UE may be unable to acquire the GNSS position associated with the UE.

As shown by reference number 502, the UE may determine a GNSS position associated with the UE. The GNSS position may indicate a geographic location associated with the UE. The UE may connect to one or more satellites associated with a GNSS in order to obtain the GNSS position. The UE may not perform the NTN cMTC/NB-IoT operation when acquiring the GNSS position. For example, the UE may be in an idle mode when acquiring the GNSS position. In some aspects, the GNSS position may be associated with a GNSS validity timer. The UE may start the GNSS validity timer after determining the GNSS position. The GNSS validity timer may be executed at the UE. The GNSS position may be valid for a certain period of time based at least in part on the GNSS validity timer.

As shown by reference number 504, the UE may receive, from the network node, a closed loop command. A closed loop command feature may be enabled via RRC signaling, and the closed loop command may be received from the network node via additional RRC signaling or via a MAC control element (MAC-CE). For example, the UE may be configured via RRC signaling to indicate that the UE may receive closed loop commands (e.g., RRC may only enable this feature), and then the UE may receive the closed loop command via the additional RRC signaling or the MAC-CE. The UE may receive the closed loop command when in a connected mode (e.g., an RRC connected mode). The closed loop command may be associated with separate flags for time and frequency. The closed loop command may indicate a time correction and/or a frequency correction. The time correction and/or the frequency correction may be based at least in part on a movement of the UE and/or changes in a delay and/or a Doppler shift observed by the network node from transmitted uplink signals. For example, the UE may move from the GNSS position to a new location, but rather than the UE needing to switch to an idle mode to reacquire the GNSS position (e.g., determine a new GNSS position associated with the new location), the network node may transmit the closed loop command to the UE. The network node may provide the time correction and/or the frequency correction to the UE based at least in part on the new location associated with the UE. The network node may detect the new location associated with the UE (or a delay and/or a Doppler shift associated with the new location), and then the network node may transmit the closed loop command with the time correction and/or the frequency correction to the UE.

In some aspects, the closed loop command may be associated with a closed loop timer. The UE may start the closed loop timer after receiving the closed loop command from the network node. The closed loop timer may be executed at the UE. The closed loop timer may be configured via RRC signaling from the network node. Alternatively, the network node may indicate the closed loop timer in a MAC-CE carrying the closed loop command. The closed loop timer may include a first closed loop timer associated with the time correction and a second closed loop timer associated with the frequency correction.

In some aspects, the UE may apply a pre-compensation to an uplink transmission of the UE, where the pre-compensation may be based at least in part on the time correction and/or the frequency correction indicated in the closed loop command. In other words, the UE may determine the pre-compensation based at least in part on the time correction and/or the frequency correction, and then apply the pre-compensation to the uplink transmission. The UE may set the pre-compensation (e.g., a timing pre-compensation value) based at least in part on the closed loop command, and the pre-compensation value may be based at least in part on a previous timing pre-compensation value and a received timing advance (TA) command. In some cases, a TA value from the received TA command may be set to zero. The UE may no longer use a timing or frequency associated with an original GNSS position. As a result, even though the UE may be associated with the new location, the UE may still be able to perform uplink transmissions using time-frequency corrections. The closed loop command may extend a validity duration associated with the original GNSS position, and allow the UE to remain in the connected mode for a longer period of time without the UE needing to go back to the idle mode to reacquire the GNSS position.

As shown by reference number 506, the UE may perform an action based at least in part on an expiry of the GNSS validity timer and an expiry of the closed loop timer. The UE may determine that the GNSS validity timer has expired and that the closed loop timer has expired. The UE, when performing the action, may transition to an idle mode, declare an RLF, and/or reacquire the GNSS position. The UE may enter the idle mode because the GNSS position associated with the UE may no longer be valid due to a UE movement. The UE may declare the RLF because the GNSS position associated with the UE may no longer be valid due to the UE movement. The UE may reacquire the GNSS position (e.g., determine an updated GNSS position), which may only be achieved in the idle mode, and the UE may determine the pre-compensation based at least in part on the reacquired GNSS position. The UE, when performing the GNSS reacquisition, the UE may determine the updated GNSS position associated with the UE. The GNSS reacquisition may be based at least in part on a UE autonomous gap. For example, the UE may select a UE autonomous gap, during which the UE may not perform an uplink transmission. The UE may use the UE autonomous gap to perform the GNSS reacquisition. The UE, during the GNSS reacquisition, may reset a time-frequency closed loop state, and the UE may stop or reset the closed loop timer.

In some aspects, since the UE may not reacquire the GNSS position until an expiration of both the GNSS validity timer and the closed loop timer, the UE may be able to remain in the connected mode for an extended period of time. The UE may remain in the connected mode based at least in part on a non-expiry of the GNSS validity timer or the closed loop timer. In other words, as long as the GNSS validity timer or the closed loop timer has not expired, the UE may remain in the connected mode.

In some aspects, the UE may perform the action based at least in part on an expiry of an extended GNSS validity timer (e.g., an extended validity duration). The extended GNSS validity timer, when expired, may cause the UE to move to the idle mode. When the GNSS validity timer (e.g., a baseline validity duration) expires, the UE may move to the idle mode. When the GNSS validity timer expires and the closed loop timer does not expire, the UE may remain in the connected mode. When the extended GNSS validity timer expires, the UE may move to the idle mode, regardless of whether the GNSS validity timer or the closed loop timer has expired. The extended GNSS validity timer may be indicated by the UE or configured by a network node.

In some aspects, the UE may be configured, by the network node and via the RRC signaling, with a closed loop time-frequency command. Separate flags may be defined for each time and frequency (e.g., for a geostationary (GEO) satellite, frequency closed loop commands may not be needed). The UE may start the closed loop timer after receiving the closed loop time-frequency command from the network node. The UE may start the closed loop timer each time a closed loop time-frequency command is received from the network node. The closed loop timer may be an RRC configured timer, or the closed loop timer may be indicated in the MAC-CE carrying the closed loop time-frequency command. Separate closed loop timers may be defined for time correction and frequency correction. In some aspects, the UE may only move to the idle mode, declare RLF, or reacquire the GNSS position associated with the UE when both the GNSS validity timer and the closed loop timer are expired. When the GNSS validity timer and/or the closed loop timer are running, the UE may remain in the RRC connected mode, and the UE may assume that an uplink synchronization is accurate. In some cases, when UE autonomous gaps are configured, the UE may reacquire the GNSS position via the UE autonomous gap after the expiry of the closed loop timer. Further, in addition to the GNSS validity timer, the extended GNSS validity timer may be started. After the expiry of the GNSS validity timer and the expiry of the extended GNSS validity timer, the UE may move to the idle mode, declare RLF, or reacquire the GNSS position associated with the UE. The extended GNSS validity timer may be indicated by the UE, or the extended GNSS validity timer may be configured by the network node.

In some aspects, a timing advance (T_{TA}) in an NTN may be defined as: T_{TA}=(N_{TA}+N_{TA,offset}+N_{TA,adj}^{common}+N_{TA,adj}^{UE})T_{S}, where N_{TA} is a TA command received by the UE, N_{TA,offset} is a TA offset, N_{TA,adj}^{common} is a common TA adjustment, N_{TA,adj}^{UE} is a timing pre-compensation value that is based at least in part on a UE location (GNSS position) and a satellite location, and T_{S} is a period of time. The network node may correct timing issues by issuing TA commands (which may be accumulated in N_{TA}), but when the UE performs a physical random access channel (PRACH) transmission, the TA commands may be reset (e.g., N_{TA}=0).

In some aspects, the timing pre-compensation value (N_{TA,adj}^{UE}) may be adjusted based at least in part on the closed loop command (e.g., closed loop correction) received from the network node. After a reception of the closed loop command (e.g., a closed loop time command), which may fix an NTN PRACH (NPACH), the UE may set N_{TA,adj}^{UE}=N_{TA,adj}^{UE}+N_{TA}, N_{TA}=0. Alternatively, an offset k may be defined (e.g., k may be configured by the network node or indicated in a MAC-CE), such that N_{TA,adj}^{UE}=N_{TA,adj}^{UE}+N_{TA}−k, N_{TA}=k, which may provide the UE with a buffer in case N_{TA} is decreasing (N_{TA} cannot be a negative value). Further, after the GNSS reacquisition, the UE may reset its time-frequency closed loop state (e.g., N_{TA,adj}^{UE}, based at least in part on a latest ephemeris and GNSS position), and the UE may stop or reset the closed loop timers.

As indicated above, FIG. 5 is provided as an example. Other examples may differ from what is described with regard to FIG. 5.

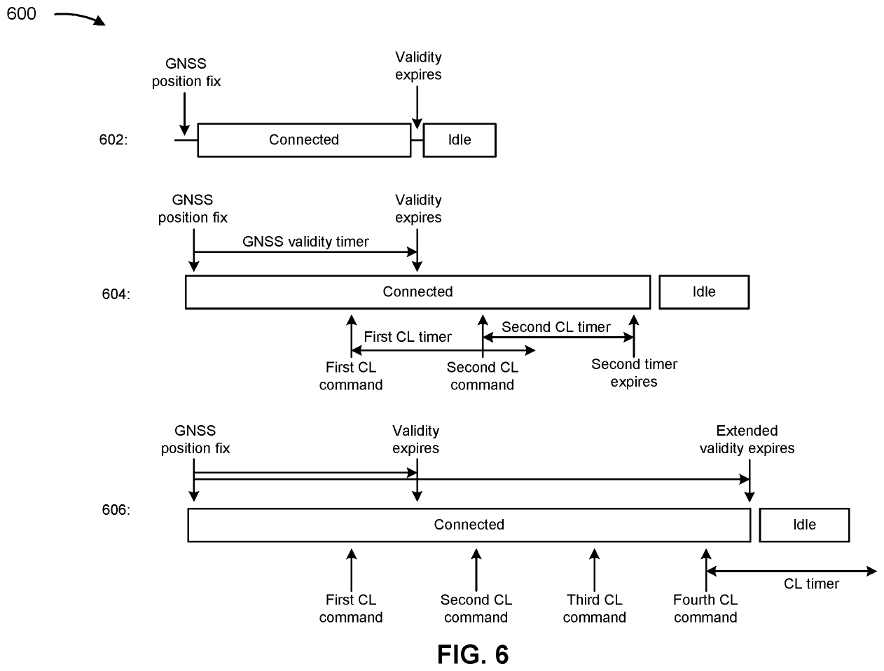

FIG. 6 is a diagram illustrating an example 600 associated with closed loop commands for extending validity durations, in accordance with the present disclosure.

As shown by reference number 602, a UE may determine a GNSS position associated with the UE (GNSS position fix), and then the UE may enter a connected mode. A validity of the GNSS position may expire, at which point the UE may move from the connected mode to an idle mode.

As shown by reference number 604, the UE may determine the GNSS position associated with the UE (GNSS position fix). The UE may be associated with the connected mode. A GNSS validity timer may start based at least in part on the determination of the GNSS position. During the connected mode, the UE may receive a first closed loop command from a network node, which may cause a first closed loop timer to be started. The GNSS validity timer may expire after a certain period of time, but since the first closed loop timer may still be running, the UE may remain in the connected mode. The UE may receive a second closed loop command from the network node, which may cause a second closed loop timer to be started. The second closed loop timer may start while the first closed loop timer is still running. After an expiry of both the first closed loop timer and the second closed loop timer, the UE may exit the connected mode and perform an action (e.g., a recovery mechanism). The action may involve transitioning to an idle mode, declaring an RLF, and/or reacquiring the GNSS position.

As shown by reference number 606, the UE may determine the GNSS position associated with the UE (GNSS position fix). The UE may be associated with the connected mode. The GNSS validity timer may start based at least in part on the determination of the GNSS position. An extended GNSS validity timer may start based at least in part on the determination of the GNSS position. During the connected mode, the UE may receive a first closed loop command from a network node. During the connected mode, the UE may also receive a second closed loop command, a third closed loop command, and a fourth closed loop command from the network node. After an expiry of both the GNSS validity timer and the extended GNSS validity timer, but before an expiry of a closed loop timer associated with the fourth closed loop command, the UE may exit the connected mode and perform the action (e.g., the recovery mechanism). The action may involve transitioning to the idle mode, declaring the RLF, and/or reacquiring the GNSS position.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with closed loop commands for extending validity durations.

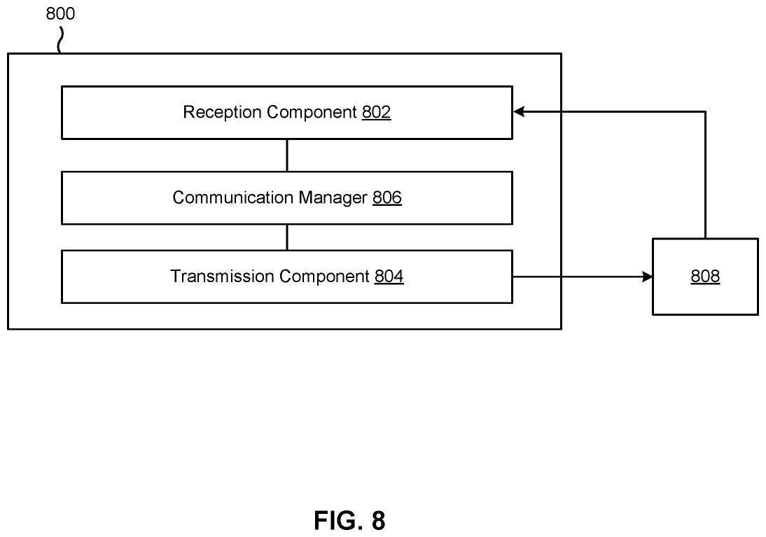

As shown in FIG. 7, in some aspects, process 700 may include determining a GNSS position associated with the UE, the GNSS position being associated with a GNSS validity timer (block 710). For example, the UE (e.g., using communication manager 806, depicted in FIG. 8) may determine a GNSS position associated with the UE, the GNSS position being associated with a GNSS validity timer, as described above.

As further shown in FIG. 7, in some aspects, process 700 may include receiving, in a connected mode, a closed loop command that is associated with a closed loop timer (block 720). For example, the UE (e.g., using reception component 802 and/or communication manager 806, depicted in FIG. 8) may receive, in a connected mode, a closed loop command that is associated with a closed loop timer, as described above.

As further shown in FIG. 7, in some aspects, process 700 may include performing an action based at least in part on an expiry of the GNSS validity timer and an expiry of the closed loop timer (block 730). For example, the UE (e.g., using communication manager 806, depicted in FIG. 8) may perform an action based at least in part on an expiry of the GNSS validity timer and an expiry of the closed loop timer, as described above.

Process 700 may include additional aspects, such as any single aspect or any combination of aspects described below and/or in connection with one or more other processes described elsewhere herein.

In a first aspect, a closed loop command feature is enabled via RRC signaling, and the closed loop command is received from a network node via additional RRC signaling or via a MAC-CE.

In a second aspect, alone or in combination with the first aspect, the closed loop command is associated with separate flags for time and frequency.

In a third aspect, alone or in combination with one or more of the first and second aspects, process 700 includes starting the GNSS validity timer based at least in part on a determination of the GNSS position.

In a fourth aspect, alone or in combination with one or more of the first through third aspects, process 700 includes starting the closed loop timer based at least in part on a receipt of the closed loop command from a network node, wherein the closed loop timer is configured via RRC signaling or is indicated in a MAC-CE carrying the closed loop command.

In a fifth aspect, alone or in combination with one or more of the first through fourth aspects, the closed loop timer includes a first closed loop timer associated with the time correction and a second closed loop timer associated with the frequency correction.

In a sixth aspect, alone or in combination with one or more of the first through fifth aspects, process 700 includes transitioning to an idle mode.

In a seventh aspect, alone or in combination with one or more of the first through sixth aspects, process 700 includes declaring an RLF.

In an eighth aspect, alone or in combination with one or more of the first through seventh aspects, the GNSS position is a first GNSS position, and process 700 includes performing a GNSS reacquisition, and the GNSS reacquisition comprises determining a second GNSS position associated with the UE.

In a ninth aspect, alone or in combination with one or more of the first through eighth aspects, the GNSS reacquisition is based at least in part on a UE autonomous gap.

In a tenth aspect, alone or in combination with one or more of the first through ninth aspects, process 700 includes resetting, based at least in part on the GNSS reacquisition, a time-frequency closed loop state, and stopping or resetting the closed loop timer.

In an eleventh aspect, alone or in combination with one or more of the first through tenth aspects, performing the action is based at least in part on an expiry of an extended GNSS validity timer, and the extended GNSS validity timer is indicated by the UE or configured by a network node.

In a twelfth aspect, alone or in combination with one or more of the first through eleventh aspects, process 700 includes remaining in the connected mode based at least in part on a non-expiry of the GNSS validity timer or the closed loop timer.

In a thirteenth aspect, alone or in combination with one or more of the first through twelfth aspects, process 700 includes setting a timing pre-compensation value based at least in part on a receipt of the closed loop command, and the timing pre-compensation value is based at least in part on a previous timing pre-compensation value and a received TA command.

In a fourteenth aspect, alone or in combination with one or more of the first through thirteenth aspects, a TA value from the received TA command is set to zero.

In a fifteenth aspect, alone or in combination with one or more of the first through fourteenth aspects, the UE is an eMTC UE or an NB-IoT UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may determine a GNSS position associated with the UE, the GNSS position being associated with a GNSS validity timer. The reception component 802 may receive, in a connected mode, a closed loop command that is associated with a closed loop timer. The communication manager 806 may perform an action based at least in part on an expiry of the GNSS validity timer and an expiry of the closed loop timer.

The communication manager 806 may start the GNSS validity timer based at least in part on a determination of the GNSS position. The communication manager 806 may start the closed loop timer based at least in part on a receipt of the closed loop command from a network node, wherein the closed loop timer is configured via RRC signaling or is indicated in a MAC-CE carrying the closed loop command. The communication manager 806 may transition to an idle mode. The communication manager 806 may declare an RLF. The communication manager 806 may perform a GNSS reacquisition, and the GNSS reacquisition may include determining a second GNSS position associated with the UE.

The communication manager 806 may reset, based at least in part on the GNSS reacquisition, a time-frequency closed loop state. The communication manager 806 may stop or reset the closed loop timer. The communication manager 806 may perform the action based at least in part on an expiry of an extended GNSS validity timer, and the extended GNSS validity timer is indicated by the UE or configured by a network node. The communication manager 806 may set a timing pre-compensation value based at least in part on a receipt of the closed loop command, and the timing pre-compensation value is based at least in part on a previous timing pre-compensation value and a received timing advance (TA) command. The communication manager 806 may remain in the connected mode based at least in part on a non-expiry of the GNSS validity timer or the closed loop timer.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: determining a global navigation satellite system (GNSS) position associated with the UE, the GNSS position being associated with a GNSS validity timer; receiving, in a connected mode, a closed loop command that is associated with a closed loop timer; and performing an action based at least in part on an expiry of the GNSS validity timer and an expiry of the closed loop timer.

Aspect 2: The method of Aspect 1, wherein a closed loop command feature is enabled via radio resource control (RRC) signaling, and the closed loop command is received from a network node via additional RRC signaling or via a medium access control control element (MAC-CE).

Aspect 3: The method of any of Aspects 1-2, wherein the closed loop command is associated with separate flags for time and frequency.

Aspect 4: The method of any of Aspects 1-3, further comprising: starting the GNSS validity timer based at least in part on a determination of the GNSS position.

Aspect 5: The method of any of Aspects 1-4, further comprising: starting the closed loop timer based at least in part on a receipt of the closed loop command from a network node, wherein the closed loop timer is configured via radio resource control (RRC) signaling or is indicated in a medium access control control element (MAC-CE) carrying the closed loop command.

Aspect 6: The method of any of Aspects 1-5, wherein the closed loop timer includes a first closed loop timer associated with the time correction and a second closed loop timer associated with the frequency correction.

Aspect 7: The method of any of Aspects 1-6, wherein performing the action comprises transitioning to an idle mode.

Aspect 8: The method of any of Aspects 1-7, wherein performing the action comprises declaring a radio link failure (RLF).

Aspect 9: The method of any of Aspects 1-8, wherein the GNSS position is a first GNSS position, and performing the action comprises performing a GNSS reacquisition, and the GNSS reacquisition comprises determining a second GNSS position associated with the UE.

Aspect 10: The method of Aspect 9, wherein the GNSS reacquisition is based at least in part on a UE autonomous gap.

Aspect 11: The method of Aspect 9, further comprising: resetting, based at least in part on the GNSS reacquisition, a time-frequency closed loop state; and stopping or resetting the closed loop timer.

Aspect 12: The method of any of Aspects 1-11, wherein performing the action is based at least in part on an expiry of an extended GNSS validity timer, and the extended GNSS validity timer is indicated by the UE or configured by a network node.

Aspect 13: The method of any of Aspects 1-12, further comprising: remaining in the connected mode based at least in part on a non-expiry of the GNSS validity timer or the closed loop timer.

Aspect 14: The method of any of Aspects 1-13, further comprising: setting a timing pre-compensation value based at least in part on a receipt of the closed loop command, and the timing pre-compensation value is based at least in part on a previous timing pre-compensation value and a received timing advance (TA) command.

Aspect 15: The method of Aspect 14, wherein a TA value from the received TA command is set to zero.

Aspect 16: The method of any of Aspects 1-15, wherein the UE is an enhanced machine-type communication (eMTC) UE or a narrowband Internet of Things (NB-IoT) UE.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
determine a global navigation satellite system (GNSS) position associated with the UE, the GNSS position being associated with a GNSS validity timer;
receive, in a connected mode, a closed loop command that is associated with a closed loop timer; and
perform an action based at least in part on an expiry of the GNSS validity timer and an expiry of the closed loop timer.

2. The apparatus of claim 1, wherein a closed loop command feature is enabled via radio resource control (RRC) signaling, and the closed loop command is received from a network node via additional RRC signaling or via a medium access control control element (MAC-CE).

3. The apparatus of claim 1, wherein the closed loop command indicates a time correction or a frequency correction for an uplink transmission of the UE, and the closed loop command is associated with separate flags for time and frequency.

4. The apparatus of claim 1, wherein the one or more processors are configured to:
start the GNSS validity timer based at least in part on a determination of the GNSS position.

5. The apparatus of claim 1, wherein the one or more processors are configured to:
start the closed loop timer based at least in part on a receipt of the closed loop command from a network node, wherein the closed loop timer is configured via radio resource control (RRC) signaling or is indicated in a medium access control control element (MAC-CE) carrying the closed loop command.

6. The apparatus of claim 1, wherein the closed loop timer includes a first closed loop timer associated with a time correction and a second closed loop timer associated with a frequency correction.

7. The apparatus of claim 1, wherein the one or more processors, when performing the action, are configured to transition to an idle mode.

8. The apparatus of claim 1, wherein the one or more processors, when performing the action, are configured to declare a radio link failure (RLF).

9. The apparatus of claim 1, wherein the GNSS position is a first GNSS position, and the one or more processors, when performing the action, are configured to perform a GNSS reacquisition, and the GNSS reacquisition comprises determining a second GNSS position associated with the UE.

10. The apparatus of claim 9, wherein the GNSS reacquisition is based at least in part on a UE autonomous gap.

11. The apparatus of claim 9, wherein the one or more processors are configured to:
reset, based at least in part on the GNSS reacquisition, a time-frequency closed loop state; and
stop or reset the closed loop timer.

12. The apparatus of claim 1, wherein the one or more processors are configured to perform the action based at least in part on an expiry of an extended GNSS validity timer, and the extended GNSS validity timer is indicated by the UE or configured by a network node.

13. The apparatus of claim 1, wherein the one or more processors are configured to:
set a timing pre-compensation value based at least in part on a receipt of the closed loop command, and the timing pre-compensation value is based at least in part on a previous timing pre-compensation value and a received timing advance (TA) command.

14. The apparatus of claim 13, wherein a TA value from the received TA command is set to zero.

15. The apparatus of claim 1, wherein the one or more processors are configured to:
remain in the connected mode based at least in part on a non-expiry of the GNSS validity timer or the closed loop timer.

16. The apparatus of claim 1, wherein the UE is an enhanced machine-type communication (eMTC) UE or a narrowband Internet of Things (NB-IoT) UE.

17. A method of wireless communication performed by a user equipment (UE), comprising:
determining a global navigation satellite system (GNSS) position associated with the UE, the GNSS position being associated with a GNSS validity timer;
receiving, in a connected mode, a closed loop command that is associated with a closed loop timer; and
performing an action based at least in part on an expiry of the GNSS validity timer and an expiry of the closed loop timer.

18. The method of claim 17, further comprising:
starting the GNSS validity timer based at least in part on a determination of the GNSS position;
starting the closed loop timer based at least in part on a receipt of the closed loop command from a network node, wherein the closed loop timer is configured via radio resource control (RRC) signaling or is indicated in a medium access control control element (MAC-CE) carrying the closed loop command;
remaining in the connected mode based at least in part on a non-expiry of the GNSS validity timer or the closed loop timer; or
setting a timing pre-compensation value based at least in part on a receipt of the closed loop command, and the timing pre-compensation value is based at least in part on a previous timing pre-compensation value and a received timing advance (TA) command.

19. The method of claim 17, wherein performing the action comprises:
transitioning to an idle mode; or
declaring a radio link failure (RLF).

20. A non-transitory computer-readable medium storing a set of instructions for wireless communication, the set of instructions comprising:
one or more instructions that, when executed by one or more processors of a user equipment (UE), cause the UE to:
determine a global navigation satellite system (GNSS) position associated with the UE, the GNSS position being associated with a GNSS validity timer;
receive, in a connected mode, a closed loop command that is associated with a closed loop timer; and
perform an action based at least in part on an expiry of the GNSS validity timer and an expiry of the closed loop timer.
